(19) United States
(12) Patent Application Publication
(10) Pub. No.: US 2026/0081214 A1
(43) Pub. Date: Mar. 19, 2026

(54) SOLID-STATE ELECTROLYTE MATERIAL, PREPARATION METHOD, ELECTROLYTELAYER, AND LITHIUM ION BATTERY

(71) Applicants: Rare Earth Functional Materials (Xiong 'an) Innovation Center Co., Ltd., Baoding (CN); GRIREM HI-TECH CO., LTD., Langfang (CN); GRIREM ADVANCED MATERIALS CO., LTD., Beijing (CN)

(72) Inventors: Jinqiu YU, Beijing (CN); Zhouqing JIANG, Beijing (CN); Linwei LI, Beijing (CN); Liang LUO, Beijing (CN); Shengming MA, Beijing (CN); Kaixin YU, Beijing (CN); Anyi ZHENG, Beijing (CN)

(73) Assignees: Rare Earth Functional Materials (Xiong 'an) Innovation Center Co., Ltd., Baoding (CN); GRIREM HI-TECH CO., LTD., Langfang (CN); GRIREM ADVANCED MATERIALS CO., LTD., Beijing (CN)

(21) Appl. No.: 19/400,203

(22) Filed: Nov. 25, 2025

Related U.S. Application Data
(63) Continuation of application No. PCT/CN2024/078572, filed on Feb. 26, 2024.

(30) Foreign Application Priority Data
Dec. 18, 2023 (CN) 202311740704.8

(51) Int. Cl. H01M 10/0562; H01M 10/0525

(52) U.S. Cl. CPC H01M 10/0562; H01M 10/0525; H01M 2300/008

(57) ABSTRACT

A solid-state electrolyte material has a chemical formula of LiₐP_{b}CₘS_{d}OₙCl_{f}, where 5.4≤a≤6.1, 0.9≤b≤1, 0<m≤0.1, 4.1≤d≤5, 0<n≤0.3, and 1≤f≤1.7. By co-doping O and C elements into an argyrodite-type sulfide electrolyte, the solid-state electrolyte material obtained maintains the excellent properties of the original electrolyte material, such as high ionic conductivity, good mechanical strength, and excellent anode stability, while effectively improving the air stability and cathode stability of the electrolyte, thereby significantly enhancing its comprehensive performance and practical value.

### CROSS-REFERENCE TO RELATED APPLICATIONS

This application is a continuation of International Application No. PCT/CN2024/078572, filed on Feb. 26, 2024, which claims priority to Chinese Patent Application No. 202311740704.8, filed on Dec. 18, 2023. The disclosures of the above-mentioned applications are hereby incorporated by reference in their entireties.

### TECHNICAL FIELD

The present application relates to the field of solid-state electrolyte materials for lithium-ion batteries, and specifically to a solid-state electrolyte material, a preparation method therefor, an electrolyte layer, and a lithium-ion battery.

### BACKGROUND

In recent years, the sales of new energy vehicles in China have been increasing year by year; however, safety incidents related to power batteries have occurred frequently. How to improve the safety of power batteries has become a key focus in the power battery industry. Currently, commercial lithium-ion power batteries use organic liquid electrolytes as a lithium-ion transport medium, and their strong volatility and flammability pose safety hazards during the battery charging and discharging processes. Compared with liquid batteries, all-solid-state batteries use non-flammable solid-state electrolytes instead of liquid electrolytes, offering higher safety and energy density, and are considered the most promising next-generation power battery technology. Sulfide solid-state electrolytes exhibit excellent mechanical ductility and high ionic conductivity comparable to that of liquid electrolytes and are one of the most application-promising solid-state electrolyte materials in the field of all-solid-state batteries.

Among different types of sulfide electrolytes, argyrodite-type sulfide solid-state electrolytes such as Li₆PS₅Cl have attracted wide attention from the academic and industrial communities due to their high room-temperature ionic conductivity, excellent mechanical properties, and good anode interface stability. However, argyrodite-type electrolytes still have drawbacks such as poor air stability and poor compatibility with oxide cathodes, which have affected their practical applications. On the one hand, argyrodite-type electrolytes are highly prone to reacting with moisture in the air; even in dry rooms with extremely low water content or inert gas glove boxes, they still react with trace amounts of moisture in the environment, leading to performance degradation, making their preparation and usage conditions too harsh to meet industrial mass production requirements. On the other hand, their poor compatibility with oxide cathode materials results in insufficient cycling stability of batteries when matched with oxide cathodes. This is primarily related to the relatively low oxidative stability potential of sulfides themselves, which are easily continuously oxidized by the cathode during the electrochemical cycling process.

### SUMMARY

The objective of the present application is to provide a solid-state electrolyte material, a preparation method therefor, an electrolyte layer, and a lithium-ion battery, which can improve air stability and matching stability with oxide cathodes.

To solve the above problems, the present application provides a sulfide solid-state electrolyte material having a chemical formula of LiₐP_{b}CₘS_{d}OₙCl_{f}, where 5.4≤a≤6.1, 0.9≤b≤1, 0<m≤0.1, 4.1≤d≤5, 0<n≤0.3, and 1≤f≤1.7.

In another aspect of the present application, preferably, 0.01≤m≤0.05 and 0.05≤n≤0.2.

In another aspect of the present application, preferably, 5.4≤a≤5.6, 0.95≤b≤1, 4.3≤d≤4.6, and 1.4≤f≤1.6.

In another aspect of the present application, preferably, the sulfide solid-state electrolyte material has an ionic conductivity ≥5×10⁻³ S/cm, an electronic conductivity <10×10⁻⁹ S/cm, and an ionic conductivity retention >50% after being placed at a −45° C. dew point for 24 hours.

In another aspect of the present application, preferably, a preparation method for the sulfide solid-state electrolyte material as described above is provided, comprising the following steps:
Step 100: mixing raw materials for forming the sulfide solid-state electrolyte material and performing grinding and mixing to obtain a first reactant;
Step 200: placing the first reactant into a quartz tube, performing vacuum sealing, then calcining, and grinding to obtain a second reactant;
Step 300: heating the second reactant under inert gas protection and introducing a carbon-containing gas to obtain the sulfide solid-state electrolyte material.

In another aspect of the present application, preferably, the raw materials of the sulfide solid-state electrolyte material comprise: Li₂S, P₂S₅, LiCl, and Li₂O.

In another aspect of the present application, preferably, the Step 200: placing the first reactant into a quartz tube, performing vacuum sealing, then calcining, and grinding to obtain a second reactant, comprises:
the vacuum degree of the vacuum sealing is ≤50 Pa;
the calcining is carried out by heating from room temperature to 400-600° C. over a period of 30-120 min and holding for a preset time.

In another aspect of the present application, preferably, the carbon-containing gas comprises at least one of CS₂ or CCl₄, and the flow rate of the introduced carbon-containing gas is 1 to 20 L/min.

In another aspect of the present application, preferably, an electrolyte layer is provided, comprising the sulfide solid-state electrolyte material as described above or a sulfide solid-state electrolyte material prepared by the preparation method as described above, wherein the electrolyte layer is formed by pressing the sulfide solid-state electrolyte material.

In another aspect of the present application, preferably, a lithium-ion battery is provided, comprising a cathode layer, an anode layer, and a solid-state electrolyte layer between the cathode and anode, wherein the solid-state electrolyte layer comprises the sulfide solid-state electrolyte material as described above, a sulfide solid-state electrolyte material prepared by the preparation method as described above, or the electrolyte layer as described above.

The above technical solutions of the present application have the following beneficial technical effects.

By co-doping O and C elements into an argyrodite-type sulfide electrolyte, the solid-state electrolyte material obtained maintains the excellent properties of the original electrolyte material, such as high ionic conductivity, good mechanical strength, and excellent anode stability, while effectively improving the air stability and cathode stability of the electrolyte, thereby significantly enhancing its comprehensive performance and practical value.

### BRIEF DESCRIPTION OF THE DRAWINGS

FIG. 1 shows the X-ray diffraction pattern of the Li_{5.54}P_{0.96}C_{0.04}S_{4.4}O_{0.1}Cl_{1.5} electrolyte according to Example 1 provided by the present application.

FIG. 2 shows the electrochemical impedance spectroscopy plot of the Li_{5.54}P_{0.96}C_{0.04}S_{4.4}O_{0.1}Cl_{1.5} electrolyte according to Example 1 provided by the present application.

### DETAILED DESCRIPTION OF THE EMBODIMENTS

To make the objective, technical solutions, and advantages of the present application clearer, the present application will be further described in detail below with reference to specific embodiments and the accompanying drawings. It should be understood that these descriptions are merely exemplary and are not intended to limit the scope of the present application. In addition, in the following description, descriptions of well-known structures and technologies are omitted to avoid unnecessarily obscuring the concepts of the present application.

Obviously, the described examples are part of the examples of the present application, rather than all the examples thereof. Based on the examples of the present application, all other examples obtained by those of ordinary skill in the art without making creative efforts shall fall within the scope of the present application.

In the description of the present application, it should be noted that the terms “first”, “second”, and “third” are used merely for descriptive purposes and shall not be construed as indicating or implying relative importance.

In addition, the technical features involved in various embodiments of the present application described below may be combined with each other as long as they do not conflict with each other.

### EXAMPLES

A sulfide solid-state electrolyte material having a chemical formula of LiₐP_{b}CₘS_{d}OₙCl_{f}, where 5.4≤a≤6.1, 0.9≤b≤1, 0<m≤0.1, 4.1≤d≤5, 0<n≤0.3, and 1≤f≤1.7.

The sulfide solid-state electrolyte provided by the present application is obtained by co-doping O and C elements into a Li₆PS₅Cl-based argyrodite-type sulfide solid-state electrolyte.

It is prior art to improve the air stability of the Li₆PS₅Cl-based argyrodite-type sulfide solid-state electrolyte by O doping. The main principle is to partially substitute S with O, forming more stable P—O bonds instead of hydrolyzable P—S bonds in the crystal structure, thereby enhancing the air stability of the electrolyte. However, while forming P—O bonds, the originally weaker Li—S bonds, which are favorable for lithium-ion transport, are partially replaced by stronger Li—O bonds, which are less favorable for lithium-ion transport, resulting in a decrease in the ionic conductivity of the electrolyte. As shown in a comparative example of the present application, the sulfide electrolyte with a small amount of O doping exhibits an improvement in room-temperature ionic conductivity retention from 36.6% (undoped) to 48.7% after being exposed to a −45° C. dew point environment for 24 h, while its initial room-temperature ionic conductivity decreases from 5.4×10⁻³ S/cm (undoped) to 4.6×10⁻³ S/cm (doped).

In the examples of the present application, doping is performed at the P site with C to improve the ionic conductivity of the sulfide electrolyte. Since the atomic radius of C is smaller than that of P, a wider lithium-ion transport channel is formed in the crystal structure after element substitution, thereby offsetting the adverse effect of O doping on ionic conductivity. In the prior art, ions such as Al, Ga, In, Si, Ge, Sn, As, and Sb are generally used to dope P. Doping with C is relatively difficult, primarily because the atomic radius of C is too small and differs significantly from that of P, making it difficult to incorporate into the lattice. If C fails to be effectively incorporated into the lattice and instead exists in the form of impurities, the electronic conductivity of the electrolyte will increase, thereby severely affecting the performance of the electrolyte in batteries, especially inducing lithium dendrite formation and thus leading to battery failure.

In the examples of the present application, CS₂ or CCl₄ is used as the carbon source, and the sulfide electrolyte is annealed in a CS₂ or CCl₄ atmosphere, enabling lattice doping with trace amounts of C. Analysis of the doped electrolyte shows that the electrolyte contains a considerable amount of carbon, with a mass fraction of up to 0.5%. However, there is no impurity phase in the X-ray diffraction (XRD) pattern of the electrolyte, and the electronic conductivity can be maintained at a low level of less than 10×10⁻⁹ S/cm.

The sulfide electrolyte co-doped with O and C exhibits both excellent air stability and room-temperature ionic conductivity. As shown in an example of the present application, the sulfide electrolyte co-doped with O and C exhibits an ionic conductivity retention of 81.2% after being exposed to a −45° C. dew point environment for 24 h, while its initial ionic conductivity reaches a high level of 8.5×10⁻³ S/cm.

Although C doping alone can also improve the ionic conductivity of the sulfide electrolyte, it fails to enhance the air stability. As shown in another comparative example of the present application, the sulfide electrolyte doped with C alone exhibits an initial ionic conductivity of 6.1×10⁻³ S/cm, while its ionic conductivity retention after being exposed to a −45° C. dew point environment for 24 h is only 32.1%.

Whether doped alone or co-doped, the doping amounts of O and C are both very limited. For example, in the case of O doping alone, if the doping amount is too high, a Li₂O impurity phase will appear in the XRD pattern of the electrolyte. In the case of O and C co-doping, if the doping amount is too high, a Li₂CO₃ impurity phase will appear in the XRD pattern of the electrolyte. In contrast, in the case of C doping alone, whether annealing is performed in a CS₂ or CCl₄ atmosphere, there is an upper limit to the C doping amount, with the maximum not exceeding 0.5%, indicating that the reaction between CS₂ or CCl₄ and the electrolyte powder may be limited to the surface of electrolyte particles. When the C content detected in the electrolyte exceeds 0.5%, the electronic conductivity of the electrolyte also increases significantly, indicating that the C no longer exists in a combined state incorporated into the lattice, but rather in the form of elemental carbon or other highly conductive impurities.

Unexpectedly, the sulfide electrolyte obtained by O and C co-doping also exhibits significantly improved stability with oxide cathodes. As shown in another set of example and comparative examples of the present application, the all-solid-state demonstration battery prepared by matching the O- and C-co-doped sulfide electrolyte with the NCM532 cathode exhibits a capacity retention of more than 71.2% after 250 cycles at a current density of 0.3C, which is much higher than the data obtained using the undoped electrolyte and the electrolytes doped with O or C alone (60.8%, 63.4%, and 53.1%, respectively). Further studies revealed that a Li₂CO₃ phase was observed at the electrolyte interface after cycling. Since no Li₂CO₃ impurity phase existed in the initial electrolyte, this Li₂CO₃ phase is likely formed during the electrochemical cycling process. It is thus speculated that the scientific mechanism by which O and C co-doping improves the stability between the electrolyte and the cathode is that trace amounts of O and C in the electrolyte form a stable Li₂CO₃ interlayer at the interface between the cathode and electrolyte particles during battery cycling, and this interlayer prevents the continuous oxidation of the sulfide electrolyte during cycling, thereby significantly enhancing cycling stability.

In an example of the present application, further, the preferred composition of the sulfide solid-state electrolyte material LiₐP_{b}CₘS_{d}OₙCl_{f} is as follows: 0.01≤m≤0.05, 0.05≤n≤0.2; 5.4≤a≤5.6, 0.95≤b≤1, 4.3≤d≤4.6, 1.4≤f≤1.6.

Within this range, the electrolyte exhibits higher ionic conductivity and excellent comprehensive performance.

In an example of the present application, further, the sulfide solid-state electrolyte material has an ionic conductivity ≥5×10⁻³ S/cm, an electronic conductivity <10×10⁻⁹ S/cm, and an ionic conductivity retention >50% after being placed at a −45° C. dew point for 24 hours. Further, the sulfide solid-state electrolyte material has an ionic conductivity ≥6×10⁻³ S/cm.

The following will further describe the embodiments of the sulfide electrolyte material and its preparation method in conjunction with specific examples of the present application. Unless otherwise specified, all raw materials used in each example are commercially available products, and all process conditions are conventional operating conditions.

A preparation method for the sulfide solid-state electrolyte material as described above, comprising the following steps:
Step 100: mixing raw materials for forming the sulfide solid-state electrolyte material and performing grinding and mixing to obtain a first reactant; the raw materials of the sulfide solid-state electrolyte material comprise: Li₂S, P₂S₅, LiCl, and Li₂O;
Step 200: placing the first reactant into a quartz tube, performing vacuum sealing, then calcining, and grinding to obtain a second reactant; the vacuum degree of the vacuum sealing is ≤50 Pa;
the calcining is carried out by heating from room temperature to 400-600° C. over a period of 30-120 min and holding for a preset time;
Step 300: heating the second reactant under inert gas protection and introducing a carbon-containing gas to obtain the sulfide solid-state electrolyte material; the carbon-containing gas comprises at least one of CS₂ or CCl₄, and the flow rate of the introduced carbon-containing gas is 1 to 20 L/min.

An electrolyte layer, comprising the sulfide solid-state electrolyte material as described above or a sulfide solid-state electrolyte material prepared by the preparation method as described above, wherein the electrolyte layer is formed by pressing the sulfide solid-state electrolyte material.

A lithium-ion battery, comprising a cathode layer, an anode layer, and a solid-state electrolyte layer between the cathode and anode, wherein the solid-state electrolyte layer comprises the sulfide solid-state electrolyte material as described above, a sulfide solid-state electrolyte material prepared by the preparation method as described above, or the electrolyte layer as described above.

### Example 1

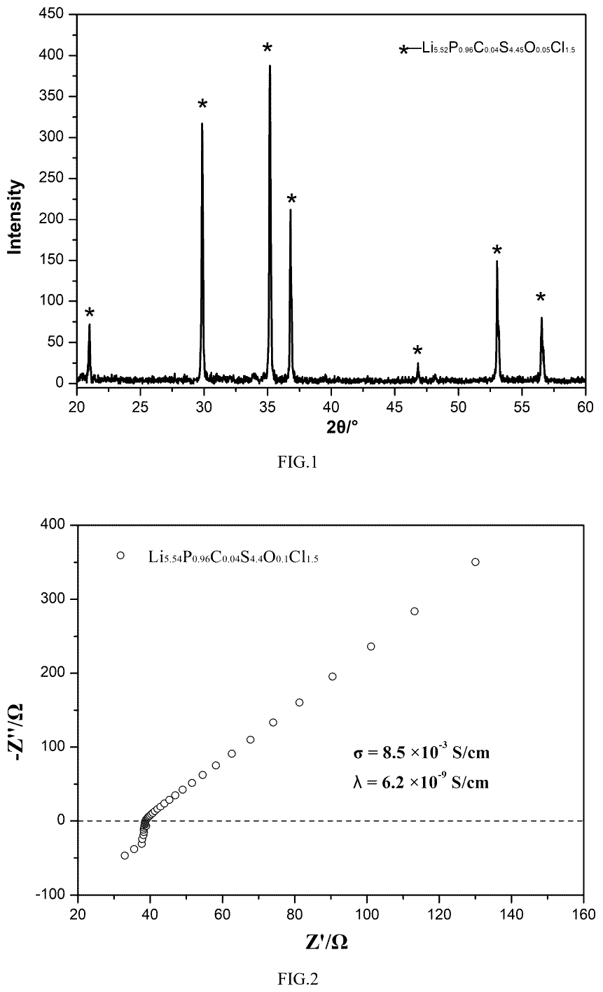

In an inert gas glove box, 8.83 g of Li₂S, 10.67 g of P₂S₅, 6.36 g of LiCl, and 0.3 g of Li₂O powder raw materials were weighed in accordance with the mass ratio corresponding to the chemical formula Li_{5.54}P_{0.96}C_{0.04}S_{4.4}O_{0.1}Cl_{1.5}. The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h to obtain a first reactant. The ground first reactant was placed into a quartz tube, and the vacuum sealing was performed with the vacuum degree maintained at 5 Pa. Then, the sealed quartz tube was placed into a muffle furnace for calcination, which was carried out by heating from room temperature to 500° C. over 60 min, holding at this temperature for 15 h, and then cooling to 50° C. over 8 hours, to obtain a second reactant. The second reactant in the quartz tube was taken out from the glove box and then ground into fine powder using an agate mortar. The ground second reactant was then transferred to an atmospheric tube furnace. The second reactant was heated to 300° C. under inert gas protection, and then CS₂ gas was introduced into the tube furnace at a flow rate of 2 L/min. After holding for 10 min, the introduction of CS₂ gas was stopped. The product was taken out after natural cooling and crushed to obtain the solid-state electrolyte material Li_{5.54}P_{0.96}C_{0.04}S_{4.4}O_{0.1}Cl_{1.5}. FIG. 1 shows the X-ray diffraction pattern of the Li_{5.54}P_{0.96}C_{0.04}S_{4.4}O_{0.1}Cl_{1.5} electrolyte according to Example 1 provided by the present application; FIG. 2 shows the electrochemical impedance spectroscopy plot of the Li_{5.54}P_{0.96}C_{0.04}S_{4.4}O_{0.1}Cl_{1.5} electrolyte according to Example 1 provided by the present application. As shown in FIGS. 1 and 2, the solid-state electrolyte material of this example exhibits no impurity phase and good electrochemical performance.

### Example 2

In an inert gas glove box, 8.4 g of Li₂S, 10.56 g of P₂S₅, 6.36 g of LiCl, and 0.6 g of Li₂O powder raw materials were weighed in accordance with the mass ratio corresponding to the chemical formula Li_{5.54}P_{0.96}C_{0.04}S_{4.4}O_{0.1}Cl_{1.5} The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h to obtain a first reactant. The ground first reactant was placed into a quartz tube, and the vacuum sealing was performed with the vacuum degree maintained at 1 Pa. Then, the sealed quartz tube was placed into a muffle furnace for calcination, which was carried out by heating from room temperature to 600° C. over 90 min, holding at this temperature for 15 h, and then cooling to 50° C. over 8 hours, to obtain a second reactant. The second reactant in the quartz tube was taken out from the glove box and then ground into fine powder using an agate mortar. The ground second reactant was then transferred to an atmospheric tube furnace. The second reactant was heated to 300° C. under inert gas protection, and then CS₂ gas was introduced into the tube furnace at a flow rate of 10 L/min. After holding for 10 min, the introduction of CS₂ gas was stopped. The product was taken out after natural cooling and crushed to obtain the solid-state electrolyte material Li_{5.54}P_{0.96}C_{0.04}S_{4.4}O_{0.1}Cl_{1.5}.

### Example 3

In an inert gas glove box, 8.95 g of Li₂S, 11 g of P₂S₅, 6.36 g of LiCl, and 0.18 g of Li₂O powder raw materials were weighed in accordance with the mass ratio corresponding to the chemical formula Li_{5.54}P_{0.96}C_{0.04}S_{4.4}O_{0.1}Cl_{1.5}. The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h to obtain a first reactant. The ground first reactant was placed into a quartz tube, and the vacuum sealing was performed with the vacuum degree maintained at 20 Pa. Then, the sealed quartz tube was placed into a muffle furnace for calcination, which was carried out by heating from room temperature to 450° C. over 120 min, holding at this temperature for 15 h, and then cooling to 50° C. over 8 hours, to obtain a second reactant. The second reactant in the quartz tube was taken out from the glove box and then ground into fine powder using an agate mortar. The ground second reactant was then transferred to an atmospheric tube furnace. The second reactant was heated to 300° C. under inert gas protection, and then CS₂ gas was introduced into the tube furnace at a flow rate of 1 L/min. After holding for 10 min, the introduction of CS₂ gas was stopped. The product was taken out after natural cooling and crushed to obtain the solid-state electrolyte material Li_{5.54}P_{0.96}C_{0.04}S_{4.4}O_{0.1}Cl_{1.5}.

### Example 4

In an inert gas glove box, 9.66 g of Li₂S, 10.67 g of P₂S₅, 5.26 g of LiCl, and 0.30 g of Li₂O powder raw materials were weighed in accordance with the mass ratio corresponding to the chemical formula Li_{5.64}P_{0.96}C_{0.04}S_{4.5}O_{0.1}Cl_{1.4}. The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h to obtain a first reactant. The ground first reactant was placed into a quartz tube, and the vacuum sealing was performed with the vacuum degree maintained at 50 Pa. Then, the sealed quartz tube was placed into a muffle furnace for calcination, which was carried out by heating from room temperature to 400° C. over 30 min, holding at this temperature for 15 h, and then cooling to 50° C. over 8 hours, to obtain a second reactant. The second reactant in the quartz tube was taken out from the glove box and then ground into fine powder using an agate mortar. The ground second reactant was then transferred to an atmospheric tube furnace. The second reactant was heated to 300° C. under inert gas protection, and then CCl₄ gas was introduced into the tube furnace for reaction at a flow rate of 20 L/min. After holding for 10 min, the introduction of CCl₄ gas was stopped. The product was taken out after natural cooling and crushed to finally obtain the solid-state electrolyte material Li_{5.64}P_{0.96}C_{0.04}S_{4.5}O_{0.1}Cl_{1.4}.

### Examples 5-32

In an inert gas glove box, powder raw materials such as Li₂S, P₂S₅, LiCl, and Li₂O were weighed in accordance with different mass ratios corresponding to the chemical formula LiₐP_{b}CₘS_{d}OₙX_{f}. The above raw materials were uniformly ground and mixed using an agate mortar. Except for the difference in weighing in accordance with the element ratios in the chemical formula, all other synthesis conditions were the same as those in Example 1.

### Comparative Example 1

In an inert gas glove box, 9.2 g of Li₂S, 11.12 g of P₂S₅, and 6.36 g of LiCl powder raw materials were weighed in accordance with the ratio corresponding to the chemical formula Li_{5.5}PS_{4.5}Cl_{1.5}. The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h. The ground mixed powder was placed into a quartz tube, and the vacuum sealing was performed with the vacuum degree maintained within 50 Pa. Then, the sealed quartz tube was placed into a muffle furnace for calcination. The calcination was carried out by heating from room temperature to 500° C. over 120 min, holding at this temperature for 15 h, and then cooling to 50° C. over 8 hours. The sample in the quartz tube was taken out from the glove box and then ground into fine powder using an agate mortar to obtain the solid-state electrolyte material Li_{5.5}PS_{4.5}Cl_{1.5}.

### Comparative Example 2

In an inert gas glove box, 8.74 g of Li₂S, 11.12 g of P₂S₅, 6.36 g of LiCl, and 0.3 g of Li₂O powder raw materials were weighed in accordance with the mass ratio corresponding to the chemical formula Li_{5.5}PS_{4.4}O_{0.1}Cl_{1.5}. All other synthesis conditions were the same as those in Comparative Example 1, and finally, the solid-state electrolyte material Li_{5.5}PS_{4.4}O_{0.1}Cl_{1.5} was obtained.

### Comparative Example 3

In an inert gas glove box, 9.29 g of Li₂S, 10.67 g of P₂S₅, and 6.36 g of LiCl powder raw materials were weighed in accordance with the ratio corresponding to the chemical formula Li_{5.54}P_{0.96}C_{0.04}S_{4.4}O_{0.1}Cl_{1.5}. The above raw materials were uniformly ground and mixed using an agate mortar, then poured into a 250 ml sealed ball mill jar, and uniformly ground into fine powder using zirconia balls. The rotation speed of the ball mill was set to 300 rpm, and ball milling was performed for 12 h. The ground mixed powder was placed into a quartz tube, and the vacuum sealing was performed with the vacuum degree maintained within 50 Pa. Then, the sealed quartz tube was placed into a muffle furnace for calcination. The calcination was carried out by heating from room temperature to 500° C. over 120 min, holding at this temperature for 15 h, and then cooling to 50° C. over 8 hours. The sample in the quartz tube was taken out from the glove box and then ground into fine powder using an agate mortar. The sample obtained was then transferred to an atmospheric tube furnace. The sample was heated to 300° C. under inert gas protection, and then CS₂ gas was introduced into the tube furnace. After holding for 10 min, the introduction of CS₂ gas was stopped. The sample was taken out after natural cooling and crushed to obtain the solid-state electrolyte material Li_{5.54}P_{0.96}C_{0.04}S_{4.4}O_{0.1}Cl_{1.5}.

The following three methods are adopted as the general testing methods for sulfide electrolytes:

### 1. Ionic Conductivity Test:

The electrolyte powder is pressed into a pellet in a mold cell under a pressure of 250 MPa. The thickness of the electrolyte layer is measured and recorded as L. Subsequently, a symmetric blocking electrode cell with a configuration of steel column/electrolyte/steel column is assembled in the mold cell. The alternating current impedance of this cell under open-circuit conditions is measured, and the impedance value obtained is recorded as R. Calculation is performed using the formula σ=L/(R·S), where σ is the ionic conductivity, L is the thickness of the electrolyte layer, R is the impedance value, and S is the electrode area of the electrolyte pellet. The ionic conductivity measured at 25° C. room temperature is taken as the ionic conductivity of the electrolyte powder.

### 2. Electronic Conductivity Test:

A symmetric blocking electrode cell is assembled following the ionic conductivity test method. The average current of this cell at a voltage of 3.5 V until equilibrium is reached is tested, and the average current value obtained is recorded as I. Calculation is performed using the formula λ=L/(S×V/I), where λ is the electronic conductivity, L is the thickness of the electrolyte layer, S is the area of the electrolyte pellet, V is the equilibrium voltage 3.5 V, and I is the equilibrium current (average current value from 1700s to 1800s). The electronic conductivity measured at 25° C. room temperature is taken as the electronic conductivity of the electrolyte powder.

### 3, Ionic Conductivity Retention Test:

The electrolyte powder with an ionic conductivity of σ₀ is placed in a −45° C. dew point test chamber for 24 hours. The ionic conductivity after placement is measured and recorded as σₜ. The ionic conductivity retention is calculated as σₜ/σ₀×100%.

The test results of the chemical composition, ionic conductivity, electronic conductivity, ionic conductivity after being placed at a −45° C. dew point for 24 hours, and ionic conductivity retention of the sulfide solid-state electrolytes in Examples 1-32 and Comparative Examples 1-3 are shown in Table 1.

TABLE 1
Test Results of sulfide solid-state electrolytes in Examples 1-32 and Comparative Examples 1-3

| | | | | Ionic | |
|---|---|---|---|---|---|
| | | | | conductivity | |
| | | | | after being | |
| | | | | placed at | |
| | | | | a −45° C. dew | Ionic |
| | | Ionic | Electronic | point for | conductivity |
| | Chemical | conductivity | conductivity | 24 hours | retention |
| Group | formula | (10⁻³ S/cm) | (10⁻⁹ S/cm) | (10⁻³ S/cm) | (%) |
| Example 1 | Li_{5.54}P_{0.96}C_{0.04}S_{4.4}O_{0.1}Cl_{1.5} | 8.5 | 6.2 | 6.9 | 81.2 |
| Example 2 | Li_{5.55}P_{0.95}C_{0.05}S_{4.3}O_{0.2}Cl_{1.5} | 8.4 | 6.8 | 6.7 | 79.8 |
| Example 3 | Li_{5.51}P_{0.99}C_{0.01}S_{4.44}O_{0.06}Cl_{1.5} | 8.6 | 5.2 | 5.4 | 62.7 |
| Example 4 | Li_{5.64}P_{0.96}C_{0.04}S_{4.5}O_{0.1}Cl_{1.4} | 8.1 | 6.3 | 5.6 | 69.2 |
| Example 5 | Li_{5.65}P_{0.98}C_{0.05}S_{4.4}O_{0.2}Cl_{1.4} | 8.0 | 6.7 | 6.6 | 82.5 |
| Example 6 | Li_{5.41}P_{0.99}C_{0.01}S_{4.34}O_{0.06}Cl_{1.6} | 7.9 | 5.8 | 5.0 | 63.5 |
| Example 7 | Li_{5.53}P_{0.97}C_{0.03}S_{4.35}O_{0.17}Cl_{1.5} | 8.2 | 5.1 | 5.8 | 71.2 |
| Example 8 | Li_{5.45}P_{0.95}C_{0.05}S_{4.2}O_{0.2}Cl_{1.6} | 8.8 | 6.1 | 6.8 | 77.2 |
| Example 9 | Li_{5.61}P_{0.99}C_{0.01}S_{4.54}O_{0.06}Cl_{1.4} | 7.7 | 4.8 | 4.8 | 62.8 |
| Example 10 | Li_{5.58}P_{0.92}C_{0.08}S_{4.49}O_{0.01}Cl_{1.5} | 7.3 | 8.7 | 3.7 | 50.5 |
| Example 11 | Li_{5.58}P_{0.92}C_{0.08}S_{4.45}O_{0.05}Cl_{1.5} | 7.1 | 8.3 | 3.8 | 54.2 |
| Example 12 | Li_{5.58}P_{0.92}C_{0.08}S_{4.25}O_{0.25}Cl_{1.6} | 7.2 | 8.4 | 4.9 | 68.1 |
| Example 13 | Li_{5.58}P_{0.92}C_{0.08}S_{4.2}O_{0.3}Cl_{1.5} | 6.8 | 8.1 | 4.9 | 72.2 |
| Example 14 | Li_{5.6}P_{0.94}C_{0.1}S_{4.49}O_{0.01}Cl_{1.5} | 7.5 | 9.4 | 3.8 | 51.3 |
| Example 15 | Li_{5.6}P_{0.9}C_{0.1}S_{4.45}O_{0.05}Cl_{1.5} | 7.4 | 9.3 | 3.9 | 52.5 |
| Example 16 | Li_{5.6}P_{0.93}C_{0.1}S_{4.25}O_{0.25}Cl_{1.6} | 7.3 | 9.8 | 4.8 | 65.6 |
| Example 17 | Li_{5.6}P_{0.96}C_{0.1}S_{4.2}O_{0.3}Cl_{1.5} | 7.1 | 9.6 | 5.0 | 70.7 |
| Example 18 | Li_{5.68}P_{0.92}C_{0.08}S_{4.55}O_{0.05}Cl_{1.4} | 6.8 | 8.6 | 3.8 | 56.4 |
| Example 19 | Li_{5.48}P_{0.92}C_{0.08}S_{4.35}O_{0.05}Cl_{1.6} | 7.2 | 8.2 | 3.7 | 51.3 |
| Example 20 | Li_{5.7}P_{0.9}C_{0.1}S_{4.35}O_{0.25}Cl_{1.4} | 6.6 | 9.2 | 3.5 | 52.8 |
| Example 21 | Li_{5.5}P_{0.9}C_{0.1}S_{4.15}O_{0.25}Cl_{1.6} | 7.4 | 9.8 | 3.7 | 50.1 |
| Example 22 | Li_{5.52}P_{0.98}C_{0.02}S_{4.47}O_{0.03}Cl_{1.5} | 6.9 | 6.7 | 5.3 | 77.2 |
| Example 23 | Li_{5.52}P_{0.98}C_{0.02}S_{4.28}O_{0.24}C_{11.5} | 6.7 | 6.5 | 4.9 | 73.3 |
| Example 24 | Li_{5.56}P_{0.94}C_{0.06}S_{4.34}O_{0.16}Cl_{1.5} | 6.8 | 8.4 | 4.2 | 61.4 |
| Example 25 | Li_{5.57}P_{0.93}C_{0.07}S_{4.34}O_{0.16}Cl_{1.5} | 6.9 | 9.2 | 4.2 | 60.6 |
| Example 26 | Li_{5.74}P_{0.98}C_{0.04}S_{4.6}O_{0.1}Cl_{1.3} | 6.5 | 6.5 | 3.3 | 50.5 |
| Example 27 | Li_{5.94}P_{0.96}C_{0.04}S_{4.7}O_{0.2}Cl_{1.1} | 6.2 | 6.2 | 3.4 | 54.8 |
| Example 28 | Li_{5.43}P_{0.97}C_{0.03}S_{4.1}O_{0.3}Cl_{1.6} | 7.4 | 6.1 | 4.9 | 65.8 |
| Example 29 | Li_{6.1}P_{0.9}C_{0.1}S_{4.9}O_{0.1}Cl | 6.3 | 8.9 | 3.4 | 53.4 |
| Example 30 | Li_{5.4}P_{0.9}C_{0.1}S_{4.15}O_{0.15}Cl_{1.7} | 7.8 | 6.8 | 4.4 | 56.8 |
| Example 31 | Li₆PC_{0.1}S₅O_{0.2}Cl | 6.4 | 8.7 | 3.8 | 59.4 |
| Example 32 | Li_{5.5}PC_{0.05}S_{4.5}O_{0.1}Cl_{1.5} | 8.7 | 5.3 | 6.8 | 78.2 |
| Comparative | Li_{5.5}PS_{4.5}Cl_{1.5} | 5.4 | 10.8 | 2.0 | 36.6 |
| Example 1 | | | | | |
| Comparative | Li_{5.5}PS_{4.4}O_{0.1}Cl_{1.5} | 4.6 | 10.2 | 2.2 | 48.7 |
| Example 2 | | | | | |
| Comparative | Li_{5.54}P_{0.96}C_{0.04}S_{4.5}Cl_{1.5} | 6.1 | 11.5 | 2.0 | 32.1 |
| Example 3 | | | | | |

### Solid-State Electrolyte Cycling Stability Test:

The solid-state electrolyte is loaded into the inner container of a circular battery mold with a diameter of 10 mm. A pressure of 300 MPa is applied to the inner container and held for 90 seconds for molding to obtain a solid-state electrolyte layer. Then, the solid-state electrolyte, NCM523 cathode, and conductive carbon black are weighed and uniformly mixed in a ratio of 40:55:5 to form a cathode mixture. The inner container of the above battery mold is opened, and the cathode mixture obtained is poured onto one side of the pressed electrolyte layer. A pressure of 300 MPa is applied to the inner container and held for 90 seconds for molding to form a solid-state battery cathode layer. The inner container of the above battery mold is opened again, and a lithium-indium alloy sheet is loaded onto the other side of the electrolyte layer. A pressure of 150 MPa is applied to the inner container and held for 90 seconds for molding to form a solid-state battery anode layer. Finally, an all-solid-state lithium secondary battery is formed.

The assembled all-solid-state battery pack is placed in a 25° C. constant temperature box, and the cycling performance test of the battery is performed. The test conditions involve using a current density of 0.3C to test the first-cycle charge-discharge performance and cycle charge-discharge performance of the solid-state battery. The voltage range is set to 1.9-3.7 V (Li⁺/Li) during the test.

The test results of the battery cycling performance for all-solid-state batteries prepared using the electrolytes synthesized in Examples 1-32 and Comparative Examples 1-3 are shown in Table 2.

TABLE 2
Cycling performance test results of batteries
from Examples 1-32 and Comparative Examples 1-3

| | | First- | First- | Capacity |
|---|---|---|---|---|
| | | cycle | cycle | retention |
| | | discharge | coulombic | after 250 |
| | Chemical | capacity | efficiency | discharge |
| Group | formula | (mAh/g) | (%) | cycles (%) |
| Example 1 | Li_{5.54}P_{0.96}C_{0.04}S_{4.4}O_{0.1}Cl_{1.5} | 131 | 93.5 | 89.1 |
| Example 2 | Li_{5.55}P_{0.95}C_{0.05}S_{4.3}O_{0.2}Cl_{1.5} | 125 | 91.8 | 88.6 |
| Example 3 | Li_{5.51}P_{0.99}C_{0.01}S_{4.44}O_{0.06}Cl_{1.5} | 123 | 92.1 | 85.2 |
| Example 4 | Li_{5.64}P_{0.96}C_{0.04}S_{4.5}O_{0.1}Cl_{1.4} | 128 | 90.5 | 86.5 |
| Example 5 | Li_{5.65}P_{0.98}C_{0.05}S_{4.4}O_{0.2}Cl_{1.4} | 126 | 91.3 | 87.2 |
| Example 6 | Li_{5.41}P_{0.99}C_{0.01}S_{4.34}O_{0.06}Cl_{1.6} | 124 | 92.4 | 88.1 |
| Example 7 | Li_{5.53}P_{0.97}C_{0.03}S_{4.35}O_{0.17}Cl_{1.5} | 133 | 90.8 | 85.9 |
| Example 8 | Li_{5.45}P_{0.95}C_{0.05}S_{4.2}O_{0.2}Cl_{1.6} | 122 | 92.3 | 87.2 |
| Example 9 | Li_{5.61}P_{0.99}C_{0.01}S_{4.54}O_{0.06}Cl_{1.4} | 121 | 91.5 | 85.3 |
| Example 10 | Li_{5.58}P_{0.92}C_{0.08}S_{4.49}O_{0.01}Cl_{1.5} | 113 | 85.2 | 79.5 |
| Example 11 | Li_{5.58}P_{0.92}C_{0.08}S_{4.45}O_{0.05}Cl_{1.5} | 112 | 84.3 | 76.3 |
| Example 12 | Li_{5.58}P_{0.92}C_{0.08}S_{4.25}O_{0.25}Cl_{1.6} | 114 | 85.6 | 79.1 |
| Example 13 | Li_{5.58}P_{0.92}C_{0.08}S_{4.2}O_{0.3}Cl_{1.5} | 111 | 84.9 | 76.5 |
| Example 14 | Li_{5.6}P_{0.94}C_{0.1}S_{4.49}O_{0.01}Cl_{1.5} | 108 | 78.5 | 71.3 |
| Example 15 | Li_{5.6}P_{0.9}C_{0.1}S_{4.45}O_{0.05}Cl_{1.5} | 106 | 74.2 | 65.9 |
| Example 16 | Li_{5.6}P_{0.93}C_{0.1}S_{4.25}O_{0.25}Cl_{1.6} | 109 | 75.6 | 66.8 |
| Example 17 | Li_{5.6}P_{0.96}C_{0.1}S_{4.2}O_{0.3}Cl_{1.5} | 105 | 78.9 | 72.1 |
| Example 18 | Li_{5.68}P_{0.92}C_{0.08}S_{4.55}O_{0.05}Cl_{1.4} | 115 | 82.3 | 75.1 |
| Example 19 | Li_{5.48}P_{0.92}C_{0.08}S_{4.35}O_{0.05}Cl_{1.6} | 111 | 84.6 | 76.8 |
| Example 20 | Li_{5.7}P_{0.9}C_{0.1}S_{4.35}O_{0.25}Cl_{1.4} | 106 | 76.9 | 71.2 |
| Example 21 | Li_{5.5}P_{0.9}C_{0.1}S_{4.15}O_{0.25}Cl_{1.6} | 103 | 75.4 | 72.3 |
| Example 22 | Li_{5.52}P_{0.98}C_{0.02}S_{4.47}O_{0.03}Cl_{1.5} | 106 | 85.3 | 81.3 |
| Example 23 | Li_{5.52}P_{0.98}C_{0.02}S_{4.28}O_{0.24}Cl_{1.5} | 112 | 84.6 | 80.2 |
| Example 24 | Li_{5.56}P_{0.94}C_{0.06}S_{4.34}O_{0.16}Cl_{1.5} | 105 | 86.1 | 81.5 |
| Example 25 | Li_{5.57}P_{0.93}C_{0.07}S_{4.34}O_{0.16}Cl_{1.5} | 104 | 82.1 | 79.3 |
| Example 26 | Li_{5.74}P_{0.98}C_{0.04}S_{4.6}O_{0.1}Cl_{1.3} | 115 | 81.5 | 76.3 |
| Example 27 | Li_{5.94}P_{0.96}C_{0.04}S_{4.7}O_{0.2}Cl_{1.1} | 118 | 81.1 | 74.1 |
| Example 28 | Li_{5.43}P_{0.97}C_{0.03}S_{4.1}O_{0.3}Cl_{1.6} | 112 | 85.2 | 79.5 |
| Example 29 | Li_{6.1}P_{0.9}C_{0.1}S_{4.9}O_{0.1}Cl | 108 | 81.9 | 73.4 |
| Example 30 | Li_{5.4}P_{0.9}C_{0.1}S_{4.15}O_{0.15}Cl_{1.7} | 117 | 83.2 | 76.3 |
| Example 31 | Li₆PC_{0.1}S₅O_{0.2}Cl | 109 | 82.3 | 74.5 |
| Example 32 | Li_{5.5}PC_{0.05}S_{4.5}O_{0.1}Cl_{1.5} | 130 | 92.1 | 88.5 |
| Comparative | Li_{5.5}PS_{4.5}Cl_{1.5} | 95 | 68.3 | 60.8 |
| Example 1 | | | | |
| Comparative | Li_{5.5}PS_{4.4}O_{0.1}Cl_{1.5} | 94 | 71.7 | 65.2 |
| Example 2 | | | | |
| Comparative | Li_{5.54}P_{0.96}C_{0.04}S_{4.5}Cl_{1.5} | 98 | 72.8 | 53.1 |
| Example 3 | | | | |

In summary, the sulfide solid-state electrolyte material obtained in the present application exhibits improved stability between the electrolyte and the cathode due to co-doping with O and C. The scientific mechanism is that trace amounts of O and C in the electrolyte form a stable Li₂CO₃ interlayer at the interface between the cathode and electrolyte particles during battery cycling, and this interlayer prevents the continuous oxidation of the sulfide electrolyte during cycling, thereby significantly enhancing cycling stability. Moreover, it exhibits high ionic conductivity. When the contents of O and C co-doping in the examples of the present application are used, no impurity phase appears in the XRD pattern of the electrolyte, and the electrolyte exhibits excellent cycling stability with oxide cathodes during the charge-discharge processes of solid-state batteries, with comprehensive performance significantly superior to that of conventional undoped or single-doped sulfide solid-state electrolytes. Meanwhile, the material features a simple preparation method and scalable preparation, providing a good foundation for the large-scale application of solid-state electrolyte materials in all-solid-state batteries.

It should be understood that the above specific embodiments of the present application are merely used for exemplarily illustrating or explaining the principles of the present application, and do not constitute a limitation on the present application. Therefore, any modifications, equivalent substitutions, improvements, etc., made without departing from the spirit and scope of the present application shall be included within the scope of the present application. In addition, the appended claims of the present application are intended to cover all variations and modifications that fall within the scope and boundaries of the appended claims, or within the equivalent forms of such scopes and boundaries.

The present application has been described above with reference to the examples of the present application. However, these examples are merely provided for illustrative purposes and are not intended to limit the scope of the present application. The scope of the present application is defined by the appended claims and their equivalents. Without departing from the scope of the present application, those skilled in the art can make various substitutions and modifications, all of which shall fall within the scope of the present application.

Although the embodiments of the present application have been described in detail, it should be understood that various changes, substitutions, and alterations can be made to the embodiments of the present application without departing from the spirit and scope thereof.

Obviously, the above examples are merely exemplary illustrations provided for clarity, and are not intended to limit the embodiments. For those of ordinary skill in the art, other different forms of variations or modifications can be made based on the above descriptions. It is unnecessary and impossible here to enumerate all of the embodiments. However, obvious variations or modifications derived therefrom still fall within the scope of the present application.

What is claimed is:

1. A sulfide solid-state electrolyte material, wherein the sulfide solid-state electrolyte material has a chemical formula of LiₐP_{b}CₘS_{d}OₙCl_{f}, wherein 5.4≤a≤6.1, 0.9≤b≤1, 0<m≤0.1, 4.1≤d≤5, 0<n≤0.3, and 1≤f≤1.7.

2. The sulfide solid-state electrolyte material according to claim 1, wherein 0.01≤m≤0.05 and 0.05≤n≤0.2.

3. The sulfide solid-state electrolyte material according to claim 1, wherein 5.4≤a≤5.6, 0.95≤b≤1, 4.3≤d≤4.6, and 1.4≤f≤1.6.

4. The sulfide solid-state electrolyte material according to claim 1, wherein the sulfide solid-state electrolyte material has an ionic conductivity of not less than 5×10⁻³ S/cm, an electronic conductivity of less than 10×10⁻⁹ S/cm, and an ionic conductivity retention of greater than 50% after being placed at a −45° C. dew point for 24 hours.

5. A preparation method for the sulfide solid-state electrolyte material according to claim 1, comprising the following steps:
Step 100: mixing raw materials for forming the sulfide solid-state electrolyte material and performing grinding and mixing to obtain a first reactant;
Step 200: placing the first reactant into a quartz tube, performing vacuum sealing, then calcining, and grinding to obtain a second reactant; and
Step 300: heating the second reactant under inert gas protection and introducing a carbon-containing gas to obtain the sulfide solid-state electrolyte material.

6. The preparation method according to claim 5, wherein the raw materials of the sulfide solid-state electrolyte material comprise: Li₂S, P₂S₅, LiCl, and Li₂O.

7. The preparation method according to claim 5, wherein the Step 200: placing the first reactant into a quartz tube, performing vacuum sealing, then calcining, and grinding to obtain a second reactant, comprises:
the vacuum degree of the vacuum sealing is not greater than 50 Pa; and
the calcining is carried out by heating from room temperature to 400-600° C. over a period of 30-120 min and holding for a preset time.

8. The preparation method according to claim 5, wherein the carbon-containing gas comprises at least one of CS₂ or CCl₄, and the flow rate of the introduced carbon-containing gas is 1 to 20 L/min.

9. An electrolyte layer, comprising the sulfide solid-state electrolyte material according to claim 1, wherein the electrolyte layer is formed by pressing the sulfide solid-state electrolyte material.

10. A lithium-ion battery, comprising a cathode layer, an anode layer, and a solid-state electrolyte layer between the cathode and anode, wherein the solid-state electrolyte layer comprises the sulfide solid-state electrolyte material according to claim 1.
